(19) United States
(12) Patent Application Publication
(10) Pub. No.: US 2017/0171560 A1
(43) Pub. Date: Jun. 15, 2017

(54) EFFICIENT PALETTE CODING FOR SCREEN CONTENT CODINGS

(71) Applicant: SHARP KABUSHIKI KAISHA, Sakai City, Osaka (JP)

(72) Inventors: Seung-Hwan KIM, Camas, WA (US); Jie ZHAO, Camas, WA (US); Kiran Mukesh MISRA, Camas, WA (US); Christopher Andrew SEGALL, Camas, WA (US)

(73) Assignee: SHARP KABUSHIKI KAISHA, Sakai City, Osaka (JP)

(21) Appl. No.: 15/320,180

(22) PCT Filed: Jun. 18, 2015
(86) PCT No.: PCT/JP2015/003064

§ 371 Date: Dec. 19, 2016

Related U.S. Application Data
(60) Provisional application No. 62/015,164, filed on Jun. 20, 2014.
(60) Provisional application No. 62/057,749, filed on Sep. 30, 2014.

(51) Int. Cl. H04N 19/593; H04N 19/463; H04N 19/625; H04N 19/91; H04N 19/122; H04N 19/70; H04N 19/176

(52) U.S. Cl. CPC H04N 19/593; H04N 19/70; H04N 19/463; H04N 19/176; H04N 19/91; H04N 19/122; H04N 19/625

(57) ABSTRACT

The invention is: A device for decoding video data, comprising: an electric device circuitry configured to derive whether palette size for a current coding unit is equal to one; and recover the video data by a first value, in a case that the palette size for the current coding unit is not equal to one; and recover the video data by a second value, in a case that the palette size for the current coding unit is equal to one.

### TECHNICAL FIELD

The present disclosure relates generally to electronic devices. More specifically, the present disclosure relates to electronic devices utilizing palette coding in the extension of HEVC for encoding and/or decoding.

### BACKGROUND ART

Many decoders (and encoders) receive (and encoders provide) encoded data for blocks of an image. Typically, the image is divided into blocks and each of the blocks is encoded in some manner, such as using a discrete cosine transform (DCT), and provided to the decoder. The decoder receives the encoded blocks and decodes each of the blocks in some manner, such as using an inverse discrete cosine transform.

Video coding standards, such as MPEG-4 part 10 (H.264), compress video data for transmission over a channel with limited frequency bandwidth and/or limited storage capacity. These video coding standards include multiple coding stages such as intra prediction, transform from spatial domain to frequency domain, quantization, entropy coding, motion estimation, and motion compensation, in order to more effectively encode and decode frames.

The Joint Collaborative Team on Video Coding (JCT-VC) of the International Telecommunication Union Telecommunication Standardization Sector (ITU-T) Study Group 16 (SG16) Working Party 3 (WP3) and International Organization for Standardization/International Electrotechnical Commission (ISO/IEC) Joint Technical Committee 1/Subcommittee 29/Working Group 11 (JTC1/SC29/WG11) has launched a standardization effort for a video coding standard called the High Efficiency Video Coding standard (HEVC). Similar to some prior video coding standards, HEVC is block-based coding. An example of an HEVC encoder is shown in FIG. 1.

In HEVC, Context-Adaptive Binary Arithmetic Coding CABAC) is used to compress Transformed and Quantized Coefficients (TQCs) without loss. CABAC based encoding and/or decoding technique is generally context adaptive which refers to (i) adaptively coding symbols based on the values of previous symbols encoded and/or decoded in the past, and (ii) context, which identifies the set of symbols encoded and/or decoded in the past used for adaptation. The past symbols may be located in spatial and/or temporal adjacent blocks. In many cases, the context is based upon symbol values of neighboring blocks.

As mentioned above, CABAC may be used to compress TQCs without loss. By way of background, TQCs may be from different block sizes according to transform sizes (e.g., 4×4, 8×8, 16×16, 32×32). Two-dimensional (2D) TQCs may be converted into a one-dimensional (1D) array before entropy coding. In an example, 2D arrayed TQCs in a 4×4 block may be arranged as illustrated in Table (1).

TABLE (1)

| | | | |
|---|---|---|---|
| 4 | 0 | 1 | 0 |
| 3 | 2 | −1 | . . . |
| −3 | 0 | . . . | . . . |
| 0 | . . . | . . . | . . . |

When converting the 2D TQCs into a 1D array, the block may be scanned in a diagonal zig-zag fashion. Continuing with the example, the 2D arrayed TQCs illustrated in Table (1) may be converted into 1D arrayed TQCs [4, 0, 3, −3, 2, 1, 0, −1, 0, . . . ] by scanning the first row and first column, first row and second column, second row and first column, third row and first column, second row and second column, first row and third column, first row and fourth column, second row and third column, third row and second column, fourth row and first column and so on.

The 1D array of TQCs is represented by a Syntax Element (SE) in CABAC. An example of an SE for the example 1D array of TCQs is shown in FIG. 2. The SE represents the following parameters for each Coefficient Level: Last position X/Y, Significance Map, and the attributes Greater than 1, Greater than 2, Sign Information, and Absolute −3.

In CABAC in HEVC, the representative SE is level coded. FIG. 3 shows the CABAC framework used for level coding an SE. The CABAC level coding technique includes coding symbols using stages. In the first stage, the CABAC uses a “binarizer” to map input symbols to a string of binary symbols, or “bins”. The input symbol may be a non-binary valued symbol that is binarized or otherwise converted into a string of binary (1 or 0) symbols prior to being coded into bits. The bins can be level coded into bits using either a “bypass encoding engine” or a “regular encoding engine”.

For the regular encoding engine in CABAC, in the second stage a probability model is selected. The probability model is used to arithmetic encode one or more bins of the binarized input symbols. This model may be selected from a list of available probability models depending on the context, which is a function of recently encoded symbols. The probability model stores the probability of a bin being “1” or “0”. In the third stage, an arithmetic encoder encodes each bin according to the selected probability model. There are two sub-ranges for each bin, corresponding to a “0” and a “1”. The fourth stage involves updating the probability model. The selected probability model is updated based on the actual encoded bin value (e.g., if the bin value was a “1”, the frequency count of the “1” s is increased). The decoding technique for CABAC decoding reverses the process.

For the bypass encoding engine in CABAC, the second stage involves conversion of bins to bits omitting the computationally expensive context estimation and probability update stages. The bypass encoding engine assumes a fixed probability distribution for the input bins. The decoding technique for CABAC decoding reverses the process.

The CABAC encodes the symbols conceptually using two steps. In the first step, the CABAC performs a binarization of the input symbols to bins. In the second step, the CABAC performs a conversion of the bins to bits using either the bypass encoding engine or the regular encoding engine. The resulting encoded bit values are provided in the bitstream to a decoder.

The CABAC decodes the symbols conceptually using two steps. In the first step, the CABAC uses either the bypass decoding engine or the regular decoding engine to convert the input bits to bin values. In the second step, the CABAC performs debinarization to recover the transmitted symbol value for the bin values. The recovered symbol may be non-binary in nature. The recovered symbol value is used in remaining aspects of the decoder.

A digital image may contain continuous tone content and/or palettized content. Continuous tone content includes, for example, photographs or other images with gradually varying colors or tones, and typically uses a range of image tones that appears substantially continuous to the human eye. Palettized content often includes areas of perceptually important fine detail—spatially localized, high frequency variations depicting text elements or other image discontinuities. A proposed extension to the HEVC standard is optimized for screen content coding. The proposed extension can be used for applications such as remote access applications for computers. Palette coding is one aspect of the proposed extension.

In an example, the use of palette coding for a block of pixels may be signaled using a flag. In an example, the use of palette coding for a block of pixels may be inferred by the decoder using past data of the bit stream.

In an example, palette coding mode is controlled by two flags, a palette_enabled_flag and a palette_mode_flag. The palette_mode_flag is a Coding Unit (CU) level flag. A CU includes a coding block of luma samples, two corresponding coding blocks of chroma samples of a picture that has three sample arrays, or a coding block of samples of a monochrome picture or a picture that is coded using three separate color planes and syntax structures used to code the samples. A syntax structure may be a sequence parameter set (SPS) or a picture parameter set (PPS). In the former, the syntax structure contains syntax elements that apply to zero or more entire coded video sequences (CVSs) as determined by the content of a syntax element found in the PPS referred to by a syntax element found in each slice segment header. In the latter, the syntax structure contains syntax elements that apply to zero or more entire coded pictures as determined by a syntax element found in each slice segment header. The palette_enabled_flag is a flag for a different level, e.g., a higher level (e.g., sequence level). In the palette coding mode, a palette table (i.e. one or more palette tables) may be generated for each CU, and pixel values are coded using a corresponding palette table.

A palette table may include one or more palette entry values for each entry in the index table. For example, the initial entry in the example palette table of the illustrated example palette table of Table 2 includes three palette entry values.

TABLE (2)

| Index | R | G | B |
|---|---|---|---|
| 0 | 40 | 40 | 40 |
| 1 | 80 | 80 | 80 |
| 2 | 120 | 120 | 120 |
| 3 | 200 | 128 | 150 |

A palette table is generated at a CU level as follows. In a palette prediction process, a palette table prediction may be made from a previously signaled palette table. In a palette update process, a new entry may be added on top of the predicted palette table.

In the palette prediction process, the encoder side sends a previous_palette_entry_flag to indicate whether or not the corresponding entry is in the current palette table. The flag previous_palette_entry_flag is coded for all entries in the previous palette table. The count of the previous_palette_entry_flag is denoted as numPredPreviouspalette, and indicates how many number of entries from a previous palette table is reused.

In the palette update process, the encode side encodes the number of newly added entries using a syntax element called palette_num_signalled_entries. The encoder side codes pixel values for newly added entries using a syntax element called palette_entries[cldx][i], which specifies the i-th element in the palette for the color component with index cldx. Size of current palette table denoted as palette_size is determined by adding numPredPreviouspalette and the palette_num_signalled_entries.

A value of “1101” for the previous_palette_entry_flag based on the palette table of Table 2, above, would specify the predicted palette table illustrated in Table 3.

TABLE (3)

| Index | R | G | B |
|---|---|---|---|
| 0 | 40 | 40 | 40 |
| 1 | 80 | 80 | 80 |
| 2 | 200 | 128 | 150 |

A value of 2 for the palette_num_signalled_entries syntax element and values 65, 78, 200 and 250, 10, 30 for the palatte_entries would specify the current palette table illustrated in Table 4.

TABLE (4)

| Index | R | G | B |
|---|---|---|---|
| 0 | 40 | 40 | 40 |
| 1 | 80 | 80 | 80 |
| 2 | 200 | 128 | 150 |
| 3 | 65 | 78 | 200 |
| 4 | 250 | 10 | 30 |

After the current palette table is generated, each pixel in the CU is coded using the given palette table. Instead of pixel value, index information is coded where the current pixel level is replaced by a representative pixel value (palette entry), e.g., quantized pixel value, indicated by the corresponding index. The pixels in the CU are coded in a raster scan order using one of three possible modes, index_mode, copy_above_mode, and escape. In the index_mode, a palette_index is first signaled followed by value M (which is called palette_run), which means the following M palette indexes are the same as the one signaled (horizontal direction prediction). In the copy_above_mode, a value N (which is called palette_run) is transmitted to indicate that for the following N palette indexes are the same as their above neighbors, respectively (vertical direction prediction). For the escape mode, the quantized pixel value (palette_escape_val) is transmitted directly.

The syntax element palette_run_type_flag is coded to indicate run type as follows: equal to 1 to indicate copy_above_mode and equal to 0 to indicate index_mode or escape mode (if 0, escape mode if the currently coded palette_index is equal to palette_size, otherwise index_mode).

To summarize the index map coding, a palette_run_type_flag is coded. If set to 1, palette_run information is to be recovered in copy_above_mode. If equal to zero, the index information is to be recovered in escape mode or index_mode (index information is signaled). In an example, in the initial row of each CU, syntax element palette_run_type_flag may not be transmitted and the decode side may proceed as if a 0 were transmitted because there is no above line available (which means copy_above_mode cannot occur).

The palatte_run information is coded through multiple steps. The initial step(s) involve context coding, and a next step involves bypass coding. Specifically, the significance flag, the greater_than_1 flag, and the greater_than_2 flag are context coded, while the remaining level is bypass coded. For the remaining level, palette_run−3 is binarized by Golomb Rice binarization with the Rice parameter equal to three prior to bypass coding. The Golomb Rice parameter binarization with Rice parameter equal to three is known and is described in more detail in U.S. patent application Ser. No. 13/942,616, now U.S. Patent Publication 2013/0301738, which is herein incorporated by reference in its entirety.

In an example, palette coding may be performed independently for each color component of a CVS. In an example, color components may be grouped together and each group performs palette coding independently.

Steps corresponding to the steps described above may be performed in reverse order by a decoder corresponding to the encoder. In an example, the decoder may receive mode information followed by index_mode and palette_run, copy_above_mode and palette_run, or escape and palette_escape_val. If index_mode, palette_run is received, the decoder may recover to a successive set of size palette_run+1, in scan-order, of representative sample values. If copy_above_mode and palette_run is received, the decoder may recover a successive set of size palette_run+1, in scan-order, of representative pixel values copied from pixel row above. If escape and palette_escape_val is received, the decoder may recover a pixel value of palette_escape_val at the current location.

When palette coding in HEVC, processing resources may be consumed. The disclosure that follows solves this and other problems.

### CITATION LIST

### Patent Literature

PTL 1: U.S. patent application Ser. No. 13/942,616

### PTL 2: U.S. Patent Publication 2013/0301738

### SUMMARY OF INVENTION

A preferred embodiment of the present invention is: A device for decoding video data, comprising: an electric device circuitry configured to derive whether palette size for a current coding unit is equal to one; and recover the video data by a first value, in a case that the palette size for the current coding unit is not equal to one; and recover the video data by a second value, in a case that the palette size for the current coding unit is equal to one.

### BRIEF DESCRIPTION OF DRAWINGS

FIG. 1 is a block diagram of an HEVC encoder.

FIG. 2 is a table showing a syntax element according to CABAC.

FIG. 3 is a block diagram of the CABAC framework for a syntax element.

FIG. 4 is a block diagram illustrating an example of a coder and a decoder.

FIG. 5 is a flow diagram illustrating one configuration of a method for palette coding on an electronic device at the decode side.

FIG. 6 is a flow diagram illustrating one configuration of a method for palette coding on an electronic device at the decode side.

FIG. 7A is a flow diagram illustrating one configuration of a method for palette coding on an electronic device at the decode side.

FIG. 7B is a flow diagram illustrating one configuration of a method for palette coding on an electronic device at the decode side.

FIG. 7C is an example illustrating concatenated binarization between truncated Unary (TU) and Fixe Length Code (FLC).

FIG. 7D is an example illustrating generalized binarization for symbols.

FIG. 7E is an example illustrating generalized binarization for symbols.

FIG. 8 is a flow diagram illustrating one configuration of a method for palette coding on an electronic device at the decode side.

FIG. 9A is a flow diagram illustrating one configuration of a method for palette coding on an electronic device at the decode side.

FIG. 9B is a flow diagram illustrating one configuration of recovering a palette run value by selectively bypass coding.

FIG. 9C is a flow diagram illustrating another configuration of a method for palette coding on an electronic device.

FIG. 10 is a flow diagram illustrating one configuration of a method for palette coding on an electronic device at the encode side.

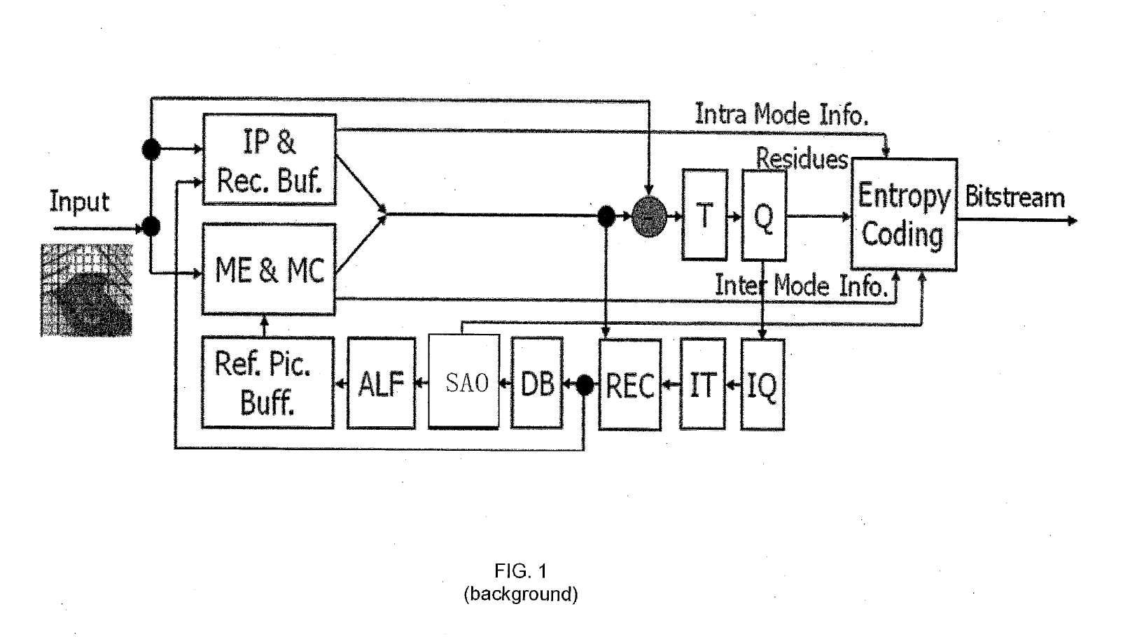

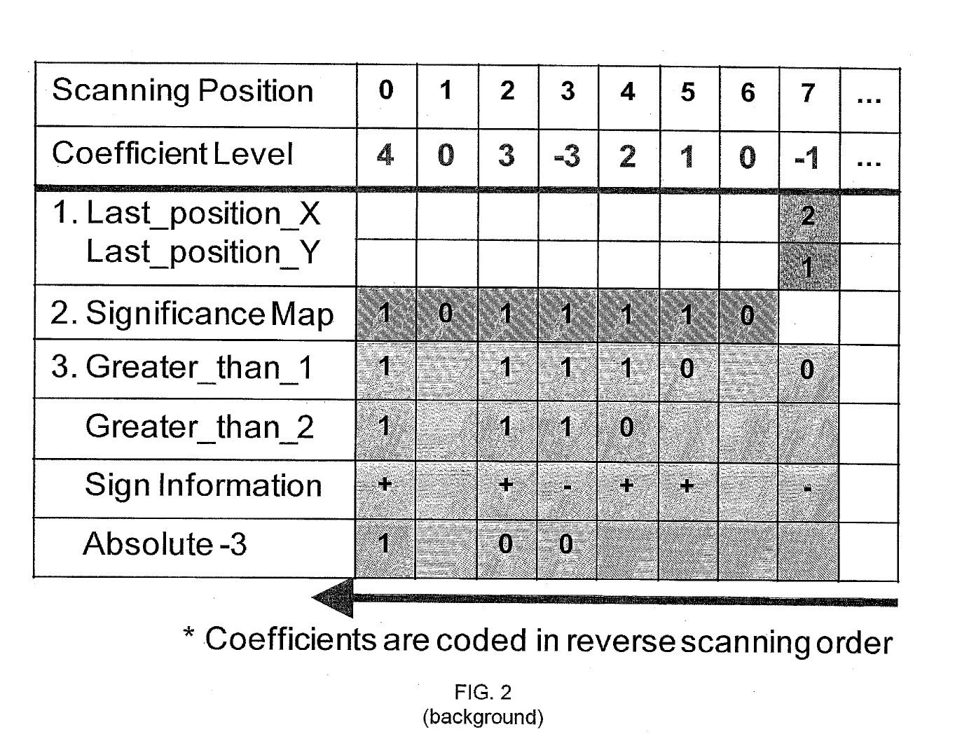

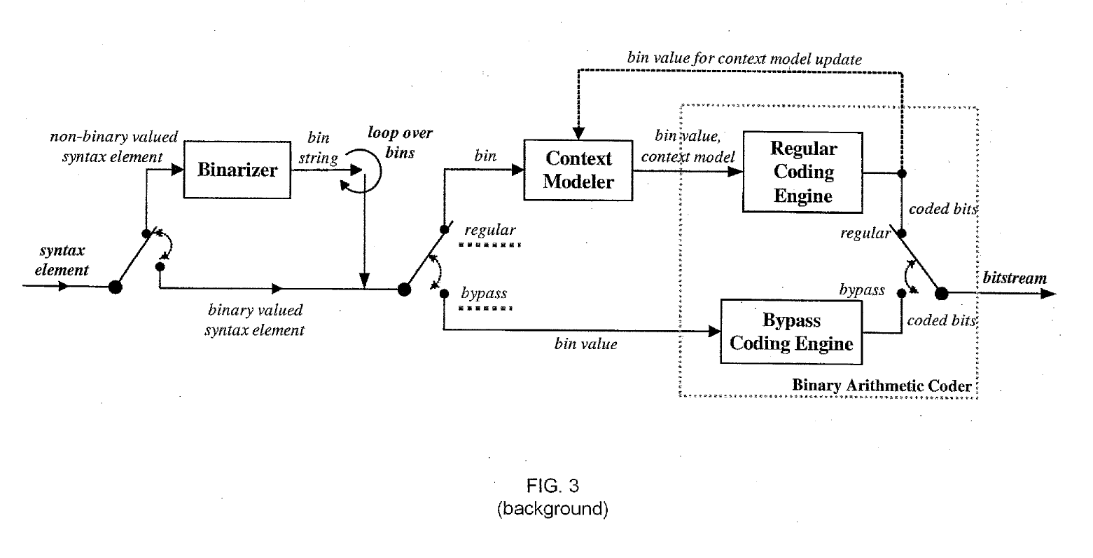

### DESCRIPTION OF EMBODIMENTS

### Definitions

Floor (x) corresponds to the largest integer less than or equal to x.

Ceil(x) corresponds to the smallest integer greater than or equal to x.

Log 2(x) corresponds to the base-2 logarithm of x.

> corresponds to the relational operator Greater than.

<= corresponds to the relational operator Less than or equal to.

< corresponds to the relational operator Less than

>= corresponds to the relational operator Greater than or equal to.

== corresponds to the relational operator Equal to.

!= corresponds to the relational operator Not equal to.

x^{y} corresponds to exponentiation and specifies x to the power of y.

= corresponds to an assignment operator.

+ corresponds to the addition operator.

When x is greater than equal to 0 then Abs(x) is equal to x. When x is less than 0 then Abs (x) is equal to −x.

x>>y corresponds to Arithmetic right shift of a two's complement integer representation of x by y binary digits. This function is defined only for non-negative integer values of y. Bits shifted into the MSBs as a result of the right shift have a value equal to the MSB of x prior to the shift operation.

x<<y corresponds to Arithmetic left shift of a two's complement integer representation of x by y binary digits. This function is defined only for non-negative integer values of y. Bits shifted into the LSBs as a result of the left shift have a value equal to 0.

++ corresponds to Increment, i.e. x++ is equivalent to x=x+1; when used in an array index, evaluates to the value of the variable prior to the increment operation.

−− corresponds to Decrement, i.e. x−− is equivalent to x=x−1; when used in an array index, evaluates to the value of the variable prior to the decrement operation.

+= corresponds to Increment by amount specified, i.e. x+=3 is equivalent to x=x+3, and x+=(−3) is equivalent to x=x+(−3).

−= corresponds to Decrement by amount specified, i.e. x−=3 is equivalent to x=x−3, and x−=(−3) is equivalent to x=x−(−3).

& corresponds to Bit-wise “and”. When operating on integer arguments, operates on a two's complement representation of the integer value. When operating on a binary argument that contains fewer bits than another argument, the shorter argument is extended by adding more significant bits equal to 0.

I corresponds to Bit-wise “or”. When operating on integer arguments, operates on a two's complement representation of the integer value. When operating on a binary argument that contains fewer bits than another argument, the shorter argument is extended by adding more significant bits equal to 0.

̂ corresponds to Bit-wise “exclusive or”. When operating on integer arguments, operates on a two's complement representation of the integer value. When operating on a binary argument that contains fewer bits than another argument, the shorter argument is extended by adding more significant bits equal to 0.

! corresponds to Boolean logical “not”.

A group of statements enclosed in curly brackets is a compound statement and is treated functionally as a single statement.

A “while” structure specifies a test of whether a condition is true, and if true, specifies evaluation of a statement (or compound statement) repeatedly until the condition is no longer true.

Object 1

while( condition )

statement

A “do . . . while” structure specifies evaluation of a statement once, followed by a test of whether a condition is true, and if true, specifies repeated evaluation of the statement until the condition is no longer true

Object 2

do

statement

while( condition )

if . . . else” structure specifies a test of whether a condition is true and, if the condition is true, specifies evaluation of a primary statement, otherwise, specifies evaluation of an alternative statement. The “else” part of the structure and the associated alternative statement is omitted if no alternative statement evaluation is needed

Object 3

if( condition )

primary statement

else

alternative statement

A “for” structure specifies evaluation of an initial statement, followed by a test of a condition, and if the condition is true, specifies repeated evaluation of a primary statement followed by a subsequent statement until the condition is no longer true.

Object 4

for( initial statement; condition; subsequent statement )

primary statement

The terms palette_enabled_flag and palette_mode_flag[x0][y0] may refer to syntax elements to enable palette mode. The palette_enabled_flag may be equal to one to specify that the palette mode may be used for intra blocks. The palette_enabled_flag may be equal to zero to specify that palette mode is not to be applied. When not present, the value of palette_enabled_flag may be inferred to be equal to zero. Palette_mode_flag[x0][y0] may be equal to one to specify that the current coding unit is coded using palette mode. The palette_mode_flag[x0][y0] may be equal to zero to specify that the current coding unit is not coded using palette mode. The array indices x0, y0 may specify the location (x0, y0) of the top-left luma sample of the considered coding block related to the top-left luma sample of the picture.

The terms previous_palette_entry_flag[i], palette_num_signalled_entries, and palette_entries[cIdx][j] may refer to syntax elements for palette table. The previous_palette_entry_flag[i] may be equal to one to specify that the platte entry from the previous used palette is copied. The previous_palette_entry_flag[i] may be equal to zero to specify that the palette entry from the previously used palette is not copied (each flag may be bypass coded). The palette_num_signalled_entries may specify the number of entries in the palette that are signaled, e.g. explicitly signaled, for the current coding unit. When palette_num_signalled_entries is not present, it may be inferred to be equal to zero. Palette_num_signaled_entries may be binarized by truncated unary code and each bin may be bypass coded. The palette_entries[cIdx][j] may specify the j-th element in the palette for the color component cIdx. Palette_entries[cIdx][j] may be binarized by fixed length coding and all bins may be bypass coded.

The definition of truncated rice binarization is specified as follows. Input to this process is a request for a TR binarization of symbolVal and input parameters cMax, and cRiceParam. Output of this process is the TR binarization of symbolVal.

A TR bin string is a concatenation of a prefix bin string and, when present, a suffix bin string.

For the derivation of the prefix bin string, the following applies:

### Listing 1

The prefix value of symbolVal, prefixVal, is derived as follows:

prefixVal=symbolVal>>cRiceParam (9-8)
The prefix of the TR bin string is specified as follows:
   If prefixVal is less than cMax>>cRiceParam, the prefix bin string is a bit string of length prefixVal+1 indexed by binIdx. The bins for binIdx less than prefixVal are equal to 1. The bin with binIdx equal to prefixVal is equal to 0. Table (5) below illustrates the bin strings of this unary binarization for prefixVal.

TABLE 5

| prefixVal | Bin string | | | | | |
|---|---|---|---|---|---|---|
| 0 | 0 | | | | | |
| 1 | 1 | 0 | | | | |
| 2 | 1 | 1 | 0 | | | |
| 3 | 1 | 1 | 1 | 0 | | |
| 4 | 1 | 1 | 1 | 1 | 0 | |
| 5 | 1 | 1 | 1 | 1 | 1 | 0 |
| . . . | | | | | | |
| binIdx | 0 | 1 | 2 | 3 | 4 | 5 |

Listing 2
Otherwise, the bin string is a bit string of length cMax>>cRiceParam with all bins being equal to 1.
When cMax is greater than symbolVal and cRiceParam is greater than 0, the suffix of the TR bin string is present and it is derived as follows:
The suffix value suffixVal is derived as follows:

suffixVal=symbolVal−((prefixVal)<<cRiceParam) (9-9)
The suffix of the TR bin string is specified by invoking the fixed-length (FL) binarization process for suffixVal with a cMax value equal to (1<<cRiceParam)−1.

For the input parameter cRiceParam=0 the TR binarization is exactly a truncated unary binarization and it is always invoked with a cMax value.

Fixed length binarization process takes as input a request for a FL binarization of input symbolVal based on input parameter cMax. The output of this process is the FL binarization associating each value symbolVal with a corresponding bin string. FL binarization is constructed by using the fixedLength bit unsigned integer bin string of the input symbol value symbolVal, where fixedLength=Ceil(Log 2(cMax+1)). The indexing of bins for the FL binarization is such that the binIdx=0 relates to the most significant bit with increasing values of binIdx towards the least significant bit.

The terms palette_run_type_flag, palette index, and palette_run, and palette_escape_val may refer to syntax elements for index map coding. The palette_run_type_flag (which may be context coded) may be equal to one to signal copy_above_mode, or may be equal to zero to signal index_mode. Palette_index may refer to an index to the palette entries (may be binarized by fixed length coding and all bins may be bypass coded). Palette_run may specify the number of consecutive locations with the same palette index. Palette_escape_val may indicatedindicate a quantized pixel value to be transmitted (under escape mode).

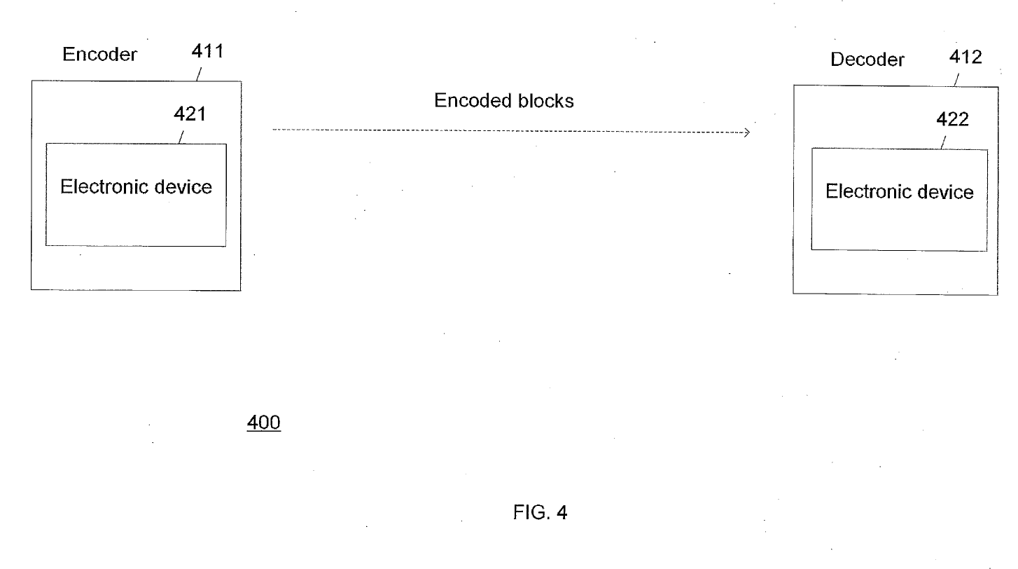

FIG. 4 is a block diagram illustrating an example of a coder and a decoder.

The system 400 includes an encoder 411 to generate encoded blocks to be decoded by a decoder 412. The encoder 411 and the decoder 412 may communicate over a network.

The encoder 411 includes an electronic device 421 configured to encode using a high throughput palette coding mode. The electronic device 421 may comprise a processor and memory in electronic communication with the processor, where the memory stores instructions being executable by the processor to perform the operations shown in FIG. 10.

The decoder 412 includes an electronic device 422 configured to decode using the high throughput palette coding mode. The electronic device 422 may comprise a processor and memory in electronic communication with the processor, where the memory stores instructions being executable to perform the operations shown in FIGS. 4, 5, 6, 7A, 7B, 8, and/or 9.

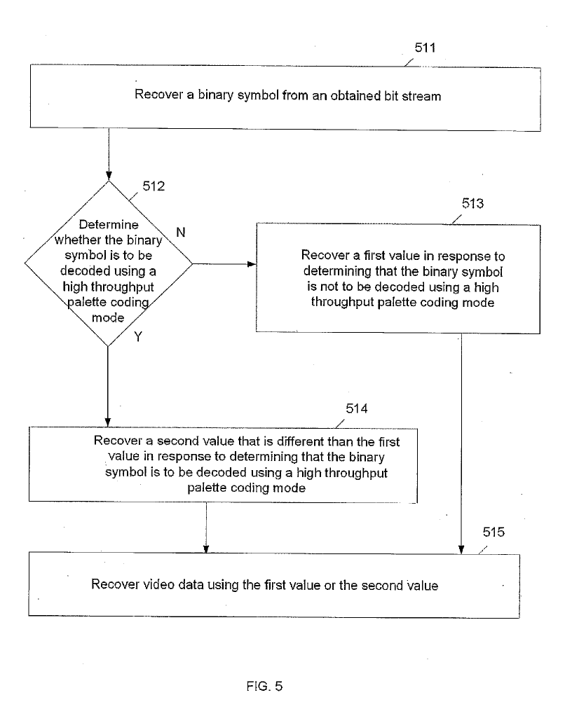

FIG. 5 is a flow diagram illustrating one configuration of a method for palette coding on an electronic device.

In block 511, the electronic device 422 may recover a binary symbol from an obtained bit stream. In diamond 512, the electronic device 422 may determine whether the binary symbol is to be decoded using a high throughput palette coding mode. The electronic device 422 may recover a first value in response to determining that the binary symbol is not to be decoded using the high throughput palette coding mode (block 513). The electronic device 422 may recover a second value that is different than the first value in response to determining that the binary symbol is to be decoded using the high throughput palette coding mode (block 514). In block 515, the electronic device 422 may recover video data using the first value or the second value.

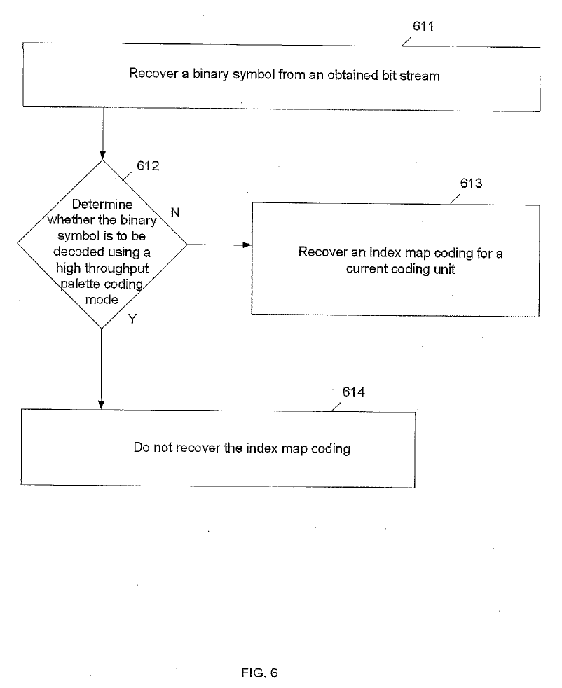

FIG. 6 is a flow diagram illustrating one configuration of a method for palette coding on an electronic device.

In block 611, the electronic device 422 may recover a binary symbol from an obtained bit stream. In diamond 612, the electronic device 422 may determine whether the binary symbol is to be decoded using a high throughput palette coding mode. In an example, diamond 612 includes determining whether a palette size for the current coding unit is equal to one. In an example, diamond 612 includes determining whether the palette size is equal to one and the index mode or the copy above mode is set for the current coding unit. In an example, diamond 612 includes determining whether the palette size is equal to one the index mode is set for the current coding unit. In an example, electronic device 422 may be configured to determine that the binary symbol is not to be decoded using the high throughput palette coding mode if the palette size is not equal to one or if the palette escape mode is set for the current coding unit. In an example, electronic device 422 may be configured to determine that the binary symbol is not to be decoded using the high throughput palette coding mode if the palette size is not equal to one or if the palette escape mode or copy above mode is set for the current coding unit. In response to determining that the binary symbol is not to be decoded using the high throughput palette coding mode, the electronic device 422 may recover an index map coding for the current coding unit in block 613. The electronic device 422 may decode the previous palette entry flag corresponding to the current coding unit using truncated unary code.

In response to determining that the binary symbol is to be decoded using the high throughput palette coding mode, the electronic device 422 may not recover the index map coding in block 614. The electronic device 422 may skip decoding the previous palette entry flag corresponding to the current coding unit. The electronic device 422 may infer that the palette_index is equal to zero and the palette_run is equal to coding unit size minus one.

In order to make a determination whether high throughput palette coding mode is to be used the electronic device 422 may receive and decode a flag in the bitstream when palette size is equal to one. In an example if the received flag is one then it indicates that the index mode or the copy above mode is used for the current coding unit. In an example if the received flag is one then it indicates that only the index mode is used for the current coding unit. In an example if the received flag is zero then it indicates that the palette escape mode is used in the current coding unit. In an example if the received flag is 0 then it indicates that the copy above mode or the palette escape mode is used in the current coding unit.

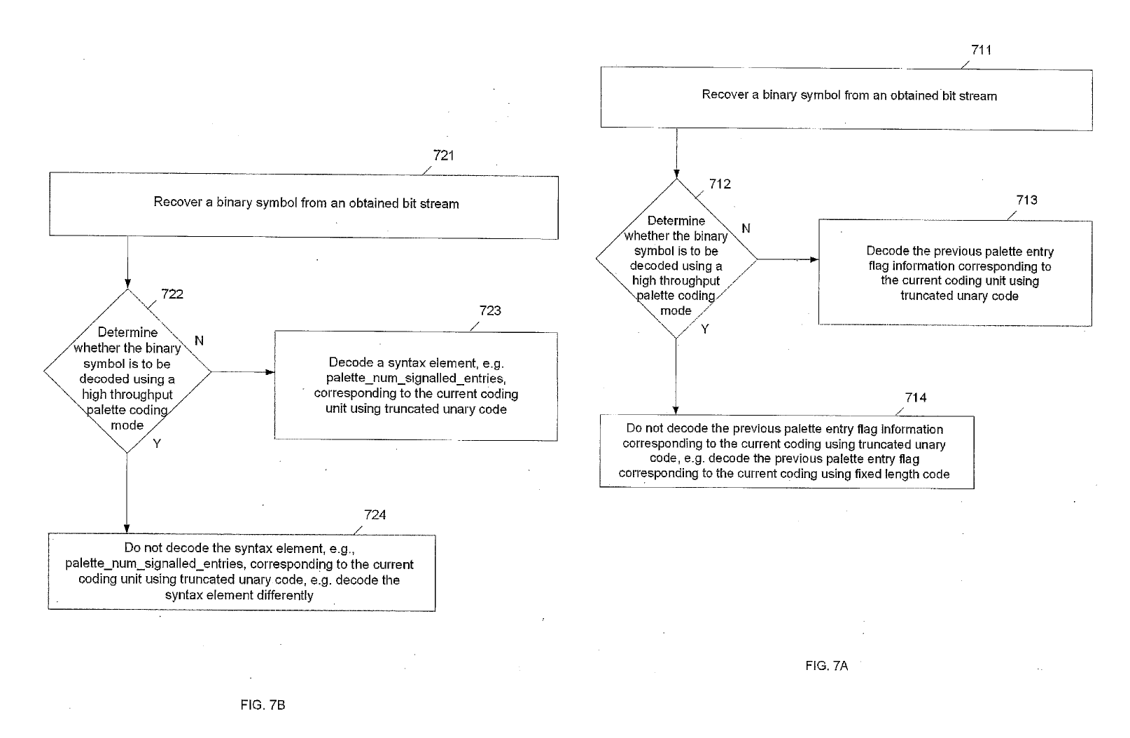

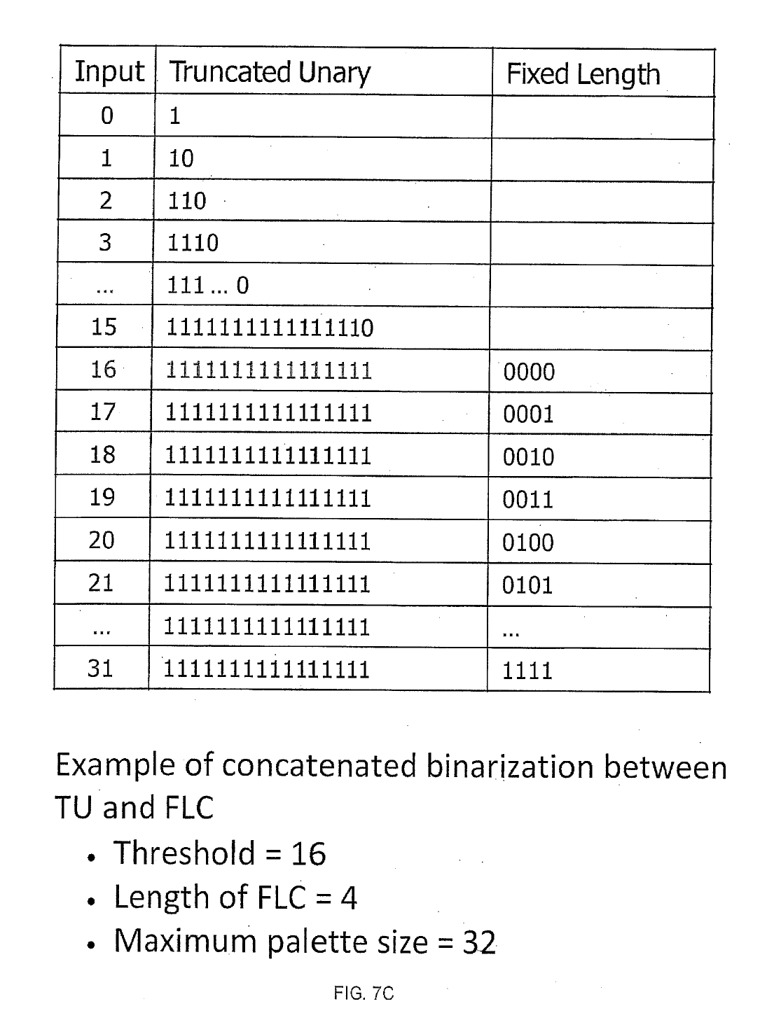

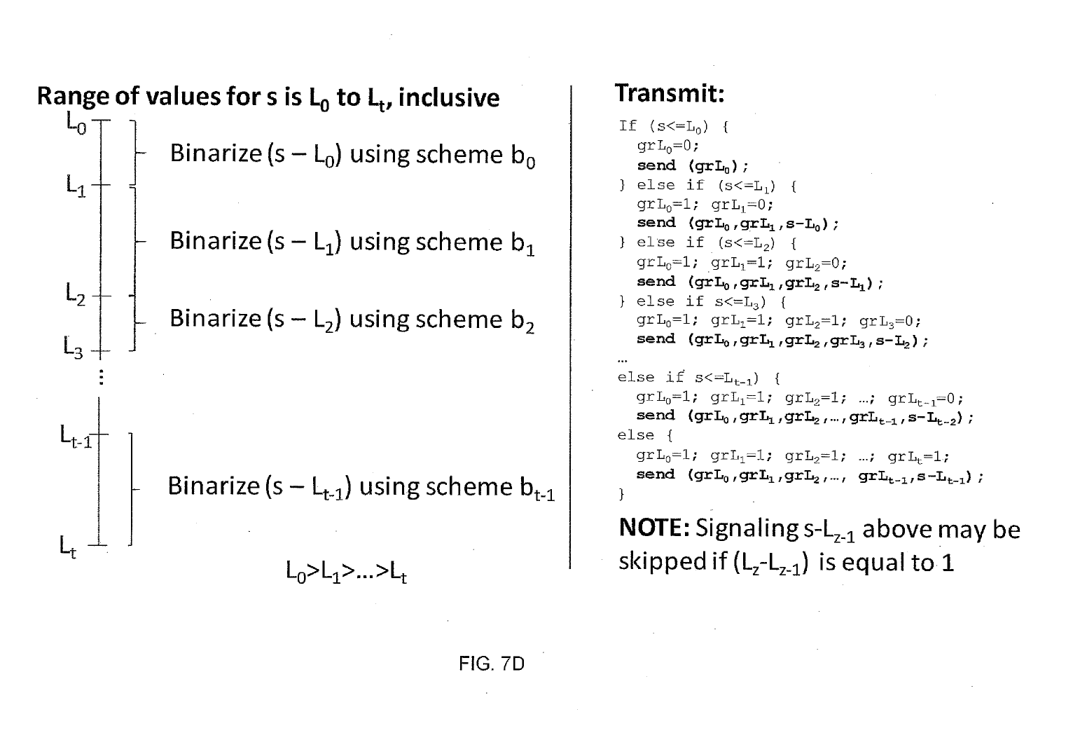

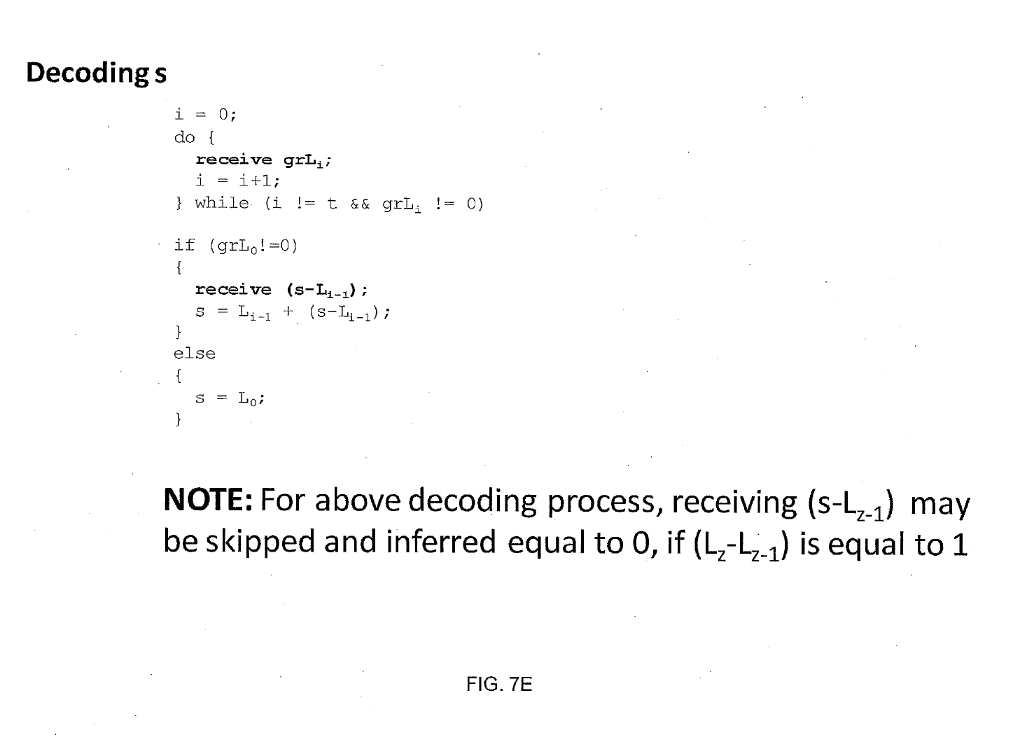

FIG. 7A is a flow diagram illustrating one configuration of a method for palette coding on an electronic device.

In block 711, the electronic device 422 may recover a binary symbol from an obtained bit stream. In diamond 712, the electronic device 422 may determine whether the binary symbol is to be decoded using a high throughput palette coding mode. In response to determining that the symbol is not to be decoded using the high throughput palette coding mode, the electronic device 422 may decode the previous palette entry flag information (e.g., previous_palette_entry_flag, palette_num_signalled_entries, and/or palette_entries) corresponding to the current coding unit using truncated unary code in block 713.

In response to determining that the symbol is to be decoded using the high throughput palette coding mode, the electronic device 422 in block 714 may not decode the previous palette entry flag information (e.g., previous_palette_entry_flag, palette_num_signalled_entries, and/or palette_entries) corresponding to the current coding unit using truncated unary code, e.g., may decode the previous palette entry flag information corresponding to the current coding using fixed length code.

A number of bits for the fixed length code may be based on the maximum palette size for the CU. In an example, if the maximum palette size is 31, a five bit fixed length code may be used. In an example, if the maximum palette size is 15, a four bit fixed length code may be used. In an example, an X length code may be used, wherein maximum palette size is not greater than 2^{X}−1. In an example, the escape mode is not signaled using a palette index value equal to palette size, then an X length code may be used, wherein the maximum palette size is not greater than 2^{X}.

In an example, electronic device 422 may be configured to determine a difference between the maximum palette size and a number of entries received from a previous palette table. Electronic device 422 may be configured to determine a number of bits for the fixed length code based on the determined difference.

In an example, electronic device 422 may be configured to utilize fixed length code of a first length to determine a first value of palette_num_signalled_entries. Electronic device 422 may be configured to determine whether to utilize fixed length code of a second length that is different than the first length to determine a second value of the palette_num_signalled_entries, wherein the determination is based on the first value. Electronic device 422 may be configured to determine the second value using the fixed length code of the second length in response to determining to utilize fixed length code of the second length (concatenated FLC).

FIG. 7B is a flow diagram illustrating one configuration of a method for palette coding on an electronic device at the decode side.

In block 721, the electronic device 422 may recover a binary symbol from an obtained bit stream. In diamond 722, the electronic device 422 may determine whether the binary symbol is to be decoded using a high throughput palette coding mode. In response to determining that the symbol is not to be decoded using the high throughput palette coding mode, the electronic device 422 may decode a syntax element, e.g. palette_num_signalled_entries, corresponding to the current coding unit using truncated unary code in block 723.

In response to determining that the symbol is to be decoded using the high throughput palette coding mode, the electronic device 422 may not decode the syntax element, e.g. previous_palette_entry_flag, corresponding to the current coding using truncated unary code, e.g., may decode the syntax element differently in block 724. In an example, the decoding in block 724 may include TB binarization. In an example, the decoding in block 724 may include concatenated binarization between TU and FLC.

In an example, in block 724 electronic device 422 may be configured to utilize Truncated Binary (TB) binarization to determine the value of palette_num_signalled_entries. Truncated Binary (TB) binarization may be defined as follows. Input to TB binarization process is a syntax element with value synVal and cMax, where cMax is the maximum allowed value of this syntax element. The bin string of the TB binarization process of synVal is specified as follows:

n=cMax+1

k=Floor(Log 2(n)) so that 2^{k}<=n<2^{k+1}

u=2^{k+1}−n.
If cMax is equal to 0, the TB binarization of the syntax element is a NULL bin string.
Otherwise, if synVal less than u, the TB bin string is specified by the FL binarization of synVal with cMax equal to k.
Otherwise (synVal greater than or equal to u) the TB bin string is specified by the FL binarization of synVal+u with cMax equal to (k+1).

In an example, electronic device 422 may be configured to receive the palette_size. The palette_size may be signaled using the FLC and/or concatenated FLC, as per the example above. Next, the electronic device 422 may decode the previous palette entry flag information (e.g., previous_palette_entry_flag). The number of decoded previous palette entry flags may be equal to the previous palette size. In an example, the decoding of previous palette entry flag may stop once the number of reused entries from previous palette table is equal to the current palette_size. When not signaled, an element of previous_palette_entry_flag may be inferred to be zero. The number of reused entries from previous palette table may be equal to the sum of values in previous_palette_entry_flag. The palette_num_signalled_entries may be determined by calculating the difference of numPredPreviouspalette and the palette_size, e.g., by subtracting numPredPreviouspalette from the palette_size, (instead of being signaled, e.g., explicitly signaled).

In response to decode the syntax element (palette_num_signalled_entries), electronic device 422 may be configured to use concatenated binarization where truncated unary binarization and fixed length binarization are used as depicted in FIG. 7C. The electronic device 422 may be configured to determine a threshold value to determine which binarization to use between truncated unary and fixed length.

In an example, the decoding of ‘palette_num_signalled_entries’ may be divided into two parts. First, the electronic device 422 may decode ‘palette_num_signalled_entries’ using truncated unary (TU) binarization which has predetermined threshold indicating the maximum value defined for the given truncated binarization. If the decoded ‘palette_num_signalled_entries’ is equal to or greater than the given threshold TH, then the fixed length code (FLC) is employed to decode additional information for ‘palette_num_signalled_entries’. In this case, ‘palette_num_signalled_entries’ is determined to be “predetermined threshold for TU+secondary information from FLC”.

In response to a threshold value TH the binarization method is switched from truncated unary to fixed length binarization as depicted in FIG. 7C. The length of Fixed length W may be determined based on the threshold value TH and the maximum palette size for the CU. In an example, if the maximum palette size is 31 and threshold value TH is equal to 16, then a W=4 bit fixed length code may be used to cover the value range from 16 to 31. In an example, a W-bit fixed length code may be used, wherein maximum palette size is not greater than 2^{W}−1+TH. In an example, the escape mode is not signaled using a palette index value equal to palette size, then an W-bit fixed length code may be used, wherein the maximum palette size is not greater than 2^{W}+TH. In an example, the length W of fixed length code may be determined based on the threshold value TH, the maximum palette size and numPredPreviouspalette. For example, if the maximum palette size is 31, numPredPreviouspalette received is 9, then the maximum possible value for ‘palette_num_signalled_entries’ is 31 minus 9, which equals 22. If the threshold value TH is equal to 16, then a three bit fixed length code may be used to code the value range from 16 to 22.

In an example, the threshold value TH may be predetermined based on the maximum palette size or may be determined from the difference of maximum palette size and the numPredPreviouspalette. In an example, the threshold TH can be signaled in the bitstream. In an example the threshold TH is explicitly signaled in the bitstream. In an example the threshold TH is inferred using past data signaled in the bitstream. In an example the threshold TH is set to a predetermined value.

In an example, the fixed length W may be predetermined based on the maximum palette size or may be determined from the difference of maximum palette size and the numPredPreviouspalette. In an example, the fixed length W can be signaled in the bitstream. In an example the fixed length W is explicitly signaled in the bitstream. In an example the fixed length W is inferred using past data signaled in the bitstream. In an example the fixed length W is set to a predetermined value.

In response to the palatte_run coding, the electronic device 422 may decode the palette run coding with different structure including the significance flag (or greater_than_0 flag), the greater_than_1 flag, and the greater_than_T flag are context coded, while the remaining level is bypass coded. Specifically, instead of greater_than_2 flag, greater_than_T flag may be used. Here, T may be any integer value which is greater than 1.

For the remaining level coding, two separate binarization may be used depends on the greater_than_T flag. If greater_than_T flag is equal to zero, which means that palette_run value is not greater than T. A binarization method which is different from the existing Golomb_Rice parameter binarization may be used to code the remaining level. In one example, V-bit fixed length code may be used, wherein T is not greater than 2^{V}+1. If greater_than_T_flag is equal to one, which means that palette_run value is greater than T, then the remaining level (i.e. palette_run−(T+1)) may be binarized using the K-th order Exp-Golomb (EGK) binarization process. In one example, instead of Golomb Rice binarization with Rice parameter equal to three, the 3-rd order Exp-Golomb (EGK) binarization may be used for the remaining level coding.

The K-th order Exp-Golomb (EGK) binarization may be defined as follows;

‘K-th order Exp-Golomb (EGK) binarization process’:
Inputs to this process is a request for an EGK binarization.

Output of this process is the EGK binarization associating each value symbolVal with a corresponding bin string.

The bin string of the EGK binarization process for each value symbolVal is specified as follows, where each call of the function put(U), with U being equal to 0 or 1, adds the binary value X at the end of the bin string:

Object 5

absV = Abs( symbolVal )
stopLoop = 0
do {

if( absV >= ( 1 << k ) ) {

put( 1 )
absV = absV − ( 1 << k )
k++

} else {

put( 0 )
while( k− − )

put( ( absV >> k ) & 1 )

stopLoop = 1

}

} while( !stopLoop )

In an example the syntax element ‘palette_num_signalled_entries’ maybe coded using truncated binarization.

FIGS. 7D-E corresponds to a binarization approach for a symbol with value s. The symbol value s may range from L₀ to Lₜ both inclusive. This range is partitioned into t non-overlapping regions based on thresholds L₁, L₂, . . . Lₜ₋₁. Note, L₀>L₁> . . . >Lₜ. When transmitting s, if s is greater than L_{z} then the syntax element grL_{z} is set to 1 and signaled. If Lₐ<L_{b} then grLₐ is signaled before signaling grL_{b}. As a result of this signaling when the electronic device 422 receives the syntax element grL_{z} with value equal to 1 then it can infer that the value of s is greater L_{z}.

If, s is equal to L₀ then grL₀ is set to 0 and signaled. As a result of this signaling when the electronic device 422 receives the syntax element grL₀ with value equal to 0 it determines the value of s to be equal to L₀.

If s is greater than L_{z-1} and less than or equal to L_{z} and z is not equal to t then the transmitter sets the syntax element grL_{z} is set to 0 and signals (grL_{z}) and (s−L_{z-1}). (s−L_{z-1}) is signaled using a binarization scheme b_{z-1}. As a result of this signaling when the electronic device 422 receives the syntax element grL_{z-1} with value equal to 1 and grL_{z} with value equal to 0 then it may expect to receive (s−L_{z-1}) which is used to determine the value of s as being equal to L_{z-1}+(s−L_{z-1}).

Note, s is always less than or equal to Lₜ therefore when s is greater than Lₜ₋₁ and less than or equal to Lₜ there is no need to signal a syntax element grLₜ to the electronic device 422. In such an event, the transmitter signals only (s−Lₜ₋₁). (s−Lₜ₋₁) is signaled using a binarization scheme bₜ₋₁. As a result of this signaling when the electronic device 422 receives the syntax element grLₜ₋₁ with value equal to 1 it may expect to receive (s−Lₜ₋₁) which is used to determine the value of s as being equal to Lₜ₋₁+(s−Lₜ₋₁).

The binarization schemes b₀ to bₜ₋₁, both inclusive, may correspond to truncated unary binarization, or fixed length binarization, or any other appropriate binarization method.

In an example, ifs is greater than L_{z-1} and s is less than or equal to L_{z} and (L_{z}−L_{z-1}) is equal to 1 then (s−L_{z-1}) is always equal to 0 and signaling of (s−L_{z-1}) may be bypassed and corresponding receiving of (s−L_{z-1}) in electronic device 422 may be bypassed.

When using the binarization approach corresponding to FIGS. 7D-E the transmitter may use the signaling mechanism listed below:

Object 6

If (s<=L₀) {

grL₀=0;
send (grL₀);

} else if (s<=L₁) {

grL₀=1; grL₁=0;
send (grL₀,grL₁,s−L₀);

} else if (s<=L₂) {

grL₀=1; grL₁=1; grL₂=0;
send (grL₀,grL₁,grL₂,s−L₁);

} else if s<=L₃) {

grL₀=1; grL₁=1; grL₂=1; grL₃=0;
send (grL₀,grL₁,grL₂,grL₃,s−L₂);

...
else if s<=Lₜ₋₁) {

grL₀=1; grL₁=1; grL₂=1; ...; grLₜ₋₁=0;
send (grL₀,grL₁,grL₂,...,grLₜ₋₁,s−Lₜ₋₂);

else {

grL₀=1; grL₁=1; grL₂=1; ...; grLₜ=1;
send (grL₀,grL₁,grL₂,..., grLₜ₋₁,s−Lₜ₋₁);

In an example, signaling (s−L_{z-1}) above may be skipped if (L_{z}−L_{z-1}) is equal to 1.

When using the binarization approach corresponding to FIGS. 7D-E the electronic device 422 may use the decoding mechanism listed below:

Object 7

i = 0;
do {

receive grLᵢ;
i = i+1;

} while (i != t && grLᵢ != 0)
if (grL₀!=0)
{

receive (s−Lᵢ₋₁);
s = Lᵢ₋₁ + (s−Lᵢ₋₁);

}
else
{

s = L₀;

}

In an example, for the above decoding process, receiving (s−L_{z-1}) may be skipped and its value may be inferred to be equal to 0, if (L_{z}−L_{z-1}) is equal to 1.

The binarization approach corresponding to FIGS. 7D-E may be used to code any appropriate syntax element. In an example the binarization approach corresponding to FIGS. 7D-E may be used to code ‘palette_num_signalled_entries’.

In an example all or a subset of the threshold value L_{z} may be predetermined based on the maximum palette size or may be determined from the difference of maximum palette size and the numPredPreviouspalette. Here z may range from 0 to t, both inclusive.

In an example, all or a subset of the threshold L_{z} can be signaled in the bitstream. Here z may range from 0 to t, both inclusive.

In an example all or a subset of the threshold L_{z} is inferred using past data signaled in the bitstream, Here z may range from 0 to t, both inclusive.

In an example all or a subset of the threshold L_{z} is set to a predetermined value. Here z may range from 0 to t, both inclusive.

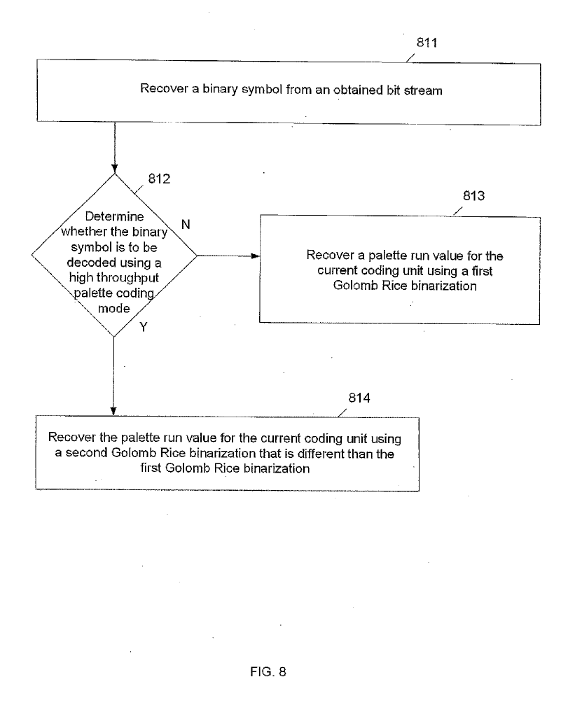

FIG. 8 is a flow diagram illustrating one configuration of a method for palette coding on an electronic device.

In block 811, electronic device 422 may recover a binary symbol from an obtained bit stream. In diamond 812, electronic device 422 may determine whether the binary symbol is to be decoded using a high throughput palette coding mode. In response to determining that the symbol is not to be decoded using the high throughput palette coding mode, electronic device 422 may recover a palette run value (e.g., palette_run) for the current coding unit using a first Golomb Rice binarization. In the first Golomb Rice binarization the Rice parameter may be equal to three.

In response to determining that the symbol is to be decoded using the high throughput palette coding mode, electronic device 422 may recover the palette run value (e.g., palette_run) for the current coding unit using a second Golomb Rice binarization that is different than the first Golomb Rice binarization. In an example, the Rice parameter of the second Golomb Rice binarization may be equal to a signaled value.

In an example, Rice parameter of the second Golomb Rice binarization may be based on a characteristic of the current coding unit or a previous coding unit. In an example, the electronic device 422 may be configured to determine a Rice parameter value for the current coding unit based on a characteristic of the current coding unit or a previous coding unit, e.g. coding unit size, palette index, or statistics of a previously decoded palette_run, or the like, or combinations thereof. In an example, the electronic device 422 may be configured to determine a Rice parameter value for the current coding unit based on data signaled in the bitstream.

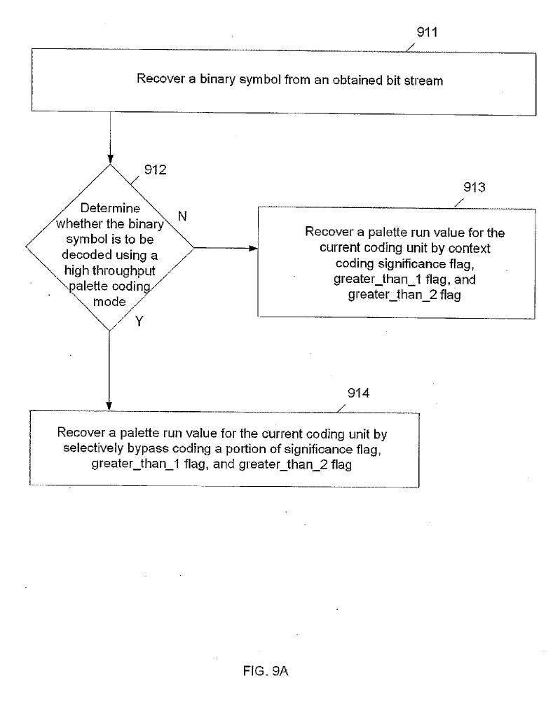

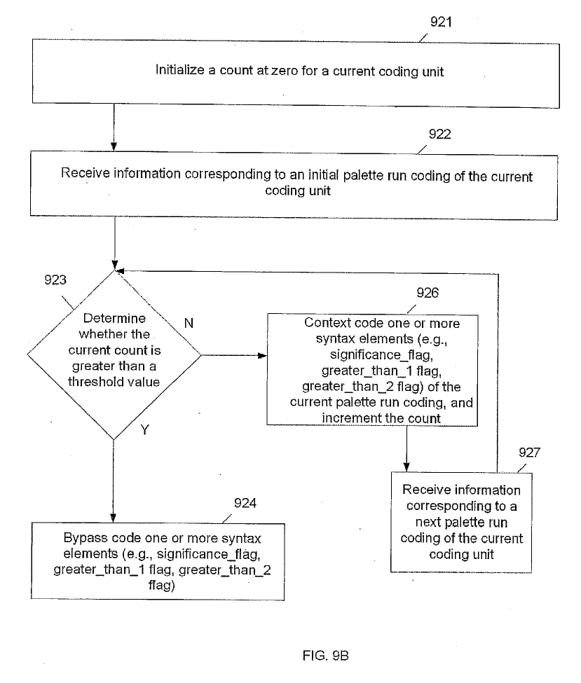

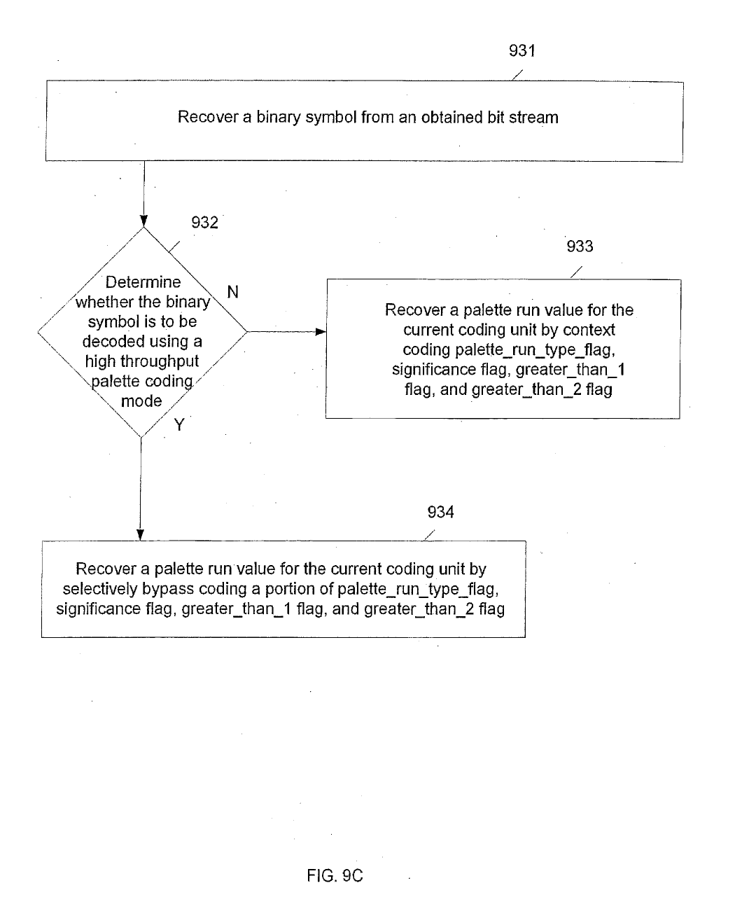

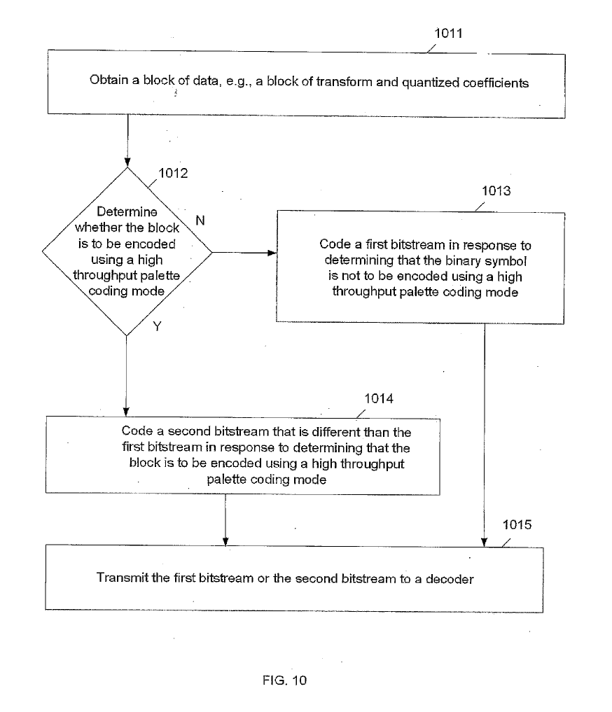

FIG. 9A is a flow diagram illustrating one configuration of a method for palette coding on an electronic device.

In block 911, the electronic device 422 may recover a binary symbol from an obtained bit stream. In diamond 912, the electronic device 422 may determine whether the binary symbol is to be decoded using a high throughput palette coding mode. In response to determining that the binary symbol is not to be decoded using the high throughput palette coding mode, the electronic device 422 may recover a palette run value (e.g., palette_run) for the current coding unit by context coding significance flag, greater_than_1 flag, and greater_than_2 flag in block 913.

In response to determining that the binary symbol is to be decoded using the high throughput palette coding mode, the electronic device 422 may recover a palette run value (e.g., palette_run) for the current coding unit by selectively bypass coding a portion of significance flag, greater_than_1 flag, and greater_than_2 flag in block 914. In an example, the electronic device 422 is configured to determine whether a count of context coded bins (of significance flag, greater_than_1 flag, and greater_than_2 flag) is greater than a threshold value. The electronic device 422 is configured to bypass code response to the count exceeding the threshold value. Therefore, if the count exceeds the threshold value, then all of the significance flag, greater_than_1 flag, and greater_than_2 flag is context coded may be bypass coded, or a first portion of the significance flag, greater_than_1 flag, and greater_than_2 flag may be context coded and a second portion of significance flag, greater_than_1 flag, and greater_than_2 flag may be bypass coded.

In an example, the threshold value is based on a quantity of pixels of the current coding unit. In an example, the threshold value is equal to the product of the count of pixels of the current coding unit and a predetermined factor. In an example, the predetermined factor is 1.5625 (i.e. 25/16^{ths}).

In an example, the threshold value may be 1.5625*CU_size*CU_size−CU_size*(CU_size−1) where CU_size is the dimensions of the coding unit of size CU_size*CU_size.

FIG. 9B is a flow diagram illustrating one configuration of recovering a palette run value by selectively bypass coding.

In block 921, the electronic device 422 initializes a count at zero for a current coding unit. In block 922, the electronic device 422 receives information corresponding to an initial palette run coding of the current coding unit.

In diamond 923, the electronic device 422 determines whether the current count is greater than a threshold value. If the current count is not greater than the threshold value in diamond 923, then in block 926 the electronic device 422 context codes one or more syntax elements (e.g., significance flag, greater_than_1 flag, and greater_than_2 flag). The electronic device 422 also increments the count according to the number of syntax elements that are context coded. In block 927, the electronic device 422 receives information corresponding to a next palette run coding of the current coding unit.

If the current count is greater than the threshold value in diamond 923, then in block 924 the electronic device 422 bypass codes one or more syntax elements (e.g., significance flag, greater_than_1 flag, and greater_than_2 flag).

In an example, block 926 includes context coding a first portion for the syntax elements, updating the count, checking the count, and selectively bypass coding a second portion of the syntax elements based on a result of the check. Therefore, in such an example a significance flag may be context coded and a greater_than_1 flag may be bypass coded, for example.

In an example, the processing device 422 may be configured to determine if the count is greater than the threshold value minus a preset value, e.g., three in an example, in response to determining that the count is not greater than the threshold value. In an example, the preset value may be based on a number of other syntax elements of the coding unit besides the palette_run syntax element. The processing device 922 may be configured to, perform the function shown in block 926 if the count is not greater than the threshold value minus the preset value. The processing device 922 may be configured to perform the function shown in block 924, if the count is greater than the threshold value minus the preset value.

FIG. 9C is a flow diagram illustrating another configuration of a method for palette coding on an electronic device.

In block 931, the electronic device 422 may recover a binary symbol from an obtained bit stream. In diamond 932, the electronic device 422 may determine whether the binary symbol is to be decoded using a high throughput palette coding mode. In response to determining that the binary symbol is not to be decoded using the high throughput palette coding mode, the electronic device 422 may recover a palette_run_type_flag and palette run value (e.g., palette_run) for the current coding unit by context coding palette_run_type_flag, significance flag, greater_than_1 flag, and greater_than_2 flag in block 933.

In response to determining that the binary symbol is to be decoded using the high throughput palette coding mode, the electronic device 422 may recover a palette_run_type_flag and palette run value (e.g., palette_run) for the current coding unit by selectively bypass coding a portion of palette_run_type_flag, significance flag, greater_than_1 flag, and greater_than_2 flag in block 934. In an example, the electronic device 422 is configured to determine whether a count of context coded bins (of palette_run_type_flag, significance flag, greater_than_1 flag, and greater_than_2 flag) is greater than a threshold value. The electronic device 422 is configured to bypass code response to the count exceeding the threshold value. Therefore, if the count exceeds the threshold value, then all of the palette_run_type_flag, significance flag, greater_than_1 flag, and greater_than_2 flag is context coded may be bypass coded, or a first portion of the palette_run_type_flag, significance flag, greater_than_1 flag, and greater_than_2 flag may be context coded and a second portion of palette_run_type_flag, significance flag, greater_than_1 flag, and greater_than_2 flag may be bypass coded.

In an example, the threshold value is based on a quantity of pixels of the current coding unit. In an example, the threshold value is equal to the product of the count of pixels of the current coding unit and a predetermined factor. In an example, the predetermined factor is 1.5625 (i.e. 25/16^{ths}).

FIG. 10 is a flow diagram illustrating one configuration of a method for palette coding on an electronic device at the encode side.

In block 1011, the electronic device 421 may receive a block of data, e.g. a block of transform and quantized coefficients. In diamond 1012, the electronic device 421 may determine whether the block of data is to be encoded using a high throughput palette coding mode. The electronic device 421 may code a first bitstream in response to determining that the binary symbol is not to be decoded using the high throughput palette coding mode (block 1013). The electronic device 421 may code a second bitstream that is different than the first bitstream in response to determining that the block of data is to be encoded using the high throughput palette coding mode (block 1014). In block 1015, the electronic device 421 may transmit the first bitstream or the second bitstream to a decoder.

In an example, the electronic device 421 may be configured to skip coding an index map coding for the block of data based on block size. In an example, the electronic device 421 may be configured to skip coding an index map coding for the block of data based on block size and/or a result of a determination of whether copy above, index mode, and/or escape mode is set is to be used for the block of data.

In an example, the electronic device 421 may be configured to determine whether to use fixed length coding for the block of data. In an example, a number of bits for the fixed length code may be based on maximum palette size. In an example, if the maximum palette size is 31, a five bit fixed length code may be used. In an example, if the maximum palette size is 15, a four bit fixed length code may be used. In an example, an X length code may be used, wherein maximum palette size is not greater than 2^{X}−1. In an example, an X length code may be used, wherein the palette size is not greater than 2^{X}. In an example, electronic device 421 may be configured to determine a difference between the maximum palette size and a number of entries of a previous palette table. Electronic device 421 may be configured to determine a number of bits for the fixed length code based on the determined difference.

In an example, the electronic device 421 may be configured to determine whether to code the syntax element palette_run using Golomb Rice binarization with Rice parameter equal to 3. In response to determining not to code the syntax element palette_run using a first Golomb Rice binarization, e.g. Golomb Rice binarization with Rice parameter equal to 3, the electronic device 421 may code the syntax element palette_run using a second different Golomb Rice binarization, e.g. a Golomb Rice binarization with a Rice parameter selected based on a characteristic of the current coding unit or a previous coding unit, e.g. coding unit size, palette index, or statistics of a previously decoded palette_run, or the like, or combinations thereof. In an example, the second Golomb Rice binarization may be adaptive based on the characteristic of the current coding unit, and the first Golomb Rice binarization may not be adaptive based on the same characteristic of the coding unit. In an example, electronic device 421 may be configured to insert a signal into the second bitstream based on the Rice parameter used for coding.

In an example, the electronic device 421 may be configured to selectively bypass code syntax elements, e.g. significance_flag, greater_than_1, and greater_than_2.

In the examples herein, coding unit level determination(s) may be made. However, the disclosure is applicable to any block of pixels using palette coding. It should be appreciated by one of ordinary skill in the art that it may be possible and practical to make these determinations at a different level than the coding unit level, e.g. a predetermined group of pixels in the CU, the transform unit level flag, the prediction unit level, the slice level, the picture level, the sequence level, or the like.

In the examples herein, selective bypass coding is described. It should be understood that the selective bypass coding determinations (wherein bypass coded bins are used instead of context coded bins) may be applicable to any syntax element that is associated with context coded bins.

The system and apparatus described above may use dedicated processor systems, micro controllers, programmable logic devices, microprocessors, or any combination thereof, to perform some or all of the operations described herein. Some of the operations described above may be implemented in software and other operations may be implemented in hardware. One or more of the operations, processes, and/or methods described herein may be performed by an apparatus, a device, and/or a system substantially similar to those as described herein and with reference to the illustrated figures.

A processing device may execute instructions or “code” stored in memory. The memory may store data as well. The processing device may include, but may not be limited to, an analog processor, a digital processor, a microprocessor, a multi-core processor, a processor array, a network processor, or the like. The processing device may be part of an integrated control system or system manager, or may be provided as a portable electronic device configured to interface with a networked system either locally or remotely via wireless transmission.

The processor memory may be integrated together with the processing device, for example RAM or FLASH memory disposed within an integrated circuit microprocessor or the like. In other examples, the memory may comprise an independent device, such as an external disk drive, a storage array, a portable FLASH key fob, or the like. The memory and processing device may be operatively coupled together, or in communication with each other, for example by an I/O port, a network connection, or the like, and the processing device may read a file stored on the memory. Associated memory may be “read only” by design (ROM) by virtue of permission settings, or not. Other examples of memory may include, but may not be limited to, WORM, EPROM, EEPROM (registered trademark), FLASH, or the like, which may be implemented in solid state semiconductor devices. Other memories may comprise moving parts, such as a conventional rotating disk drive. All such memories may be “machine-readable” and may be readable by a processing device.

Operating instructions or commands may be implemented or embodied in tangible forms of stored computer software (also known as “computer program” or “code”). Programs, or code, may be stored in a digital memory and may be read by the processing device. “Computer-readable storage medium” (or alternatively, “machine-readable storage medium”) may include all of the foregoing types of memory, as well as new technologies of the future, as long as the memory may be capable of storing digital information in the nature of a computer program or other data, at least temporarily, and as long at the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, a processing device, or any computing system. Such media may be any available media that may be locally and/or remotely accessible by a computer or a processor, and may include volatile and non-volatile media, and removable and non-removable media, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

One of skill in the art will recognize that the concepts taught herein can be tailored to a particular application in many other ways. In particular, those skilled in the art will recognize that the illustrated examples are but one of many alternative implementations that will become apparent upon reading this disclosure.

Although the specification may refer to “an”, “one”, “another”, or “some” example(s) in several locations, this does not necessarily mean that each such reference is to the same example(s), or that the feature only applies to a single example.

1. A device for decoding video data, comprising:
an electric device circuitry configured to
derive whether palette size for a current coding unit is equal to one; and
recover the video data by a first value, in a case that the palette size for the current coding unit is not equal to one; and
recover the video data by a second value, in a case that the palette size for the current coding unit is equal to one.

2. The device of claim 1, wherein the second value is different from the first value.

3. The device of claim 1, wherein an index map is recovered, in a case that the palette size for the current coding unit is not equal to one.

4. The device of claim 3, wherein the index map includes palette_run_type_flag.

5. A method for decoding video data, comprising:
deriving whether palette size for a current coding unit is equal to one; and
recovering the video data by a first value, in a case that the palette size for the current coding unit is not equal to one; and
recovering the video data by a second value, in a case that the palette size for the current coding unit is equal to one.
